(19) United States
(12) Patent Application Publication
(10) Pub. No.: US 2006/0294204 A1
(43) Pub. Date: Dec. 28, 2006

(54) Methods and devices for redirecting subscriber communication

(76) Inventor: Michael D. Kotzin, Buffalo Grove, IL (US)

Correspondence Address: MOTOROLA INC, 600 NORTH US HIGHWAY 45, ROOM AS437, LIBERTYVILLE, IL, 60048-5343, US

(21) Appl. No.: 11/168,947

(22) Filed: Jun. 28, 2005

(51) Int. Cl. G06F 15/16

(52) U.S. Cl. 709/218

(57) ABSTRACT

Methods and devices for redirecting subscriber communication using a network provider (110) other than its usual network provider (108) are disclosed herein. The electronic device (102) generates a signal having an initiating message (111). In response, the server (104) signal sends an instruction message (114) to electronic device (102). The instruction message (114) includes instructions for establishing communication over a second network different from the user's usual network provider. Once the instruction message (114) has been processed by the electronic device (102), a download request message (116) is sent to the server (104) via the second network (110). In response, the server (104) sends a download message (119) via the second network (110). Once the transaction is complete, the communication between the electronic device (102) and the second network (110) ends and the communication with the user's usual network provider (108) is restored.

### FIELD OF THE INVENTION

This disclosure generally relates to methods and devices for redirecting subscriber communication to a different network provider to download data.

### BACKGROUND

During most wireless communications, data is downloaded using the user's own home network provider. Since downloading data over a user's home network may take substantial time, the cost for the time on the network may be substantial as well. A data provider may be sending downloads to multiple individual users through multiple network providers. There is an opportunity to aggregate the service providers to provide lower cost downloads to users.

### BRIEF DESCRIPTION OF THE DRAWINGS

FIG. 1 is an exemplary system diagram depicting an electronic device in communication with a remote server via two different cellular networks;

FIG. 2 is an exemplary signal flow diagram of communication between the electronic device and the server over a first and a second network;

FIG. 3 is an exemplary flowchart showing a process including the electronic device communicating with the server via the first network and receiving an instruction message from server via first network; and

FIG. 4 is an exemplary flowchart showing the process of the server communicating with the communication device.

### DETAILED DESCRIPTION OF THE DRAWINGS

A third party, such as a business entity or vendor from which the data download originates, may wish to reduce the cost of data delivery to its customers. The third party may therefore wish to purchase a block of network (air) time from a particular radio (cellular) network service provider to provide less expensive communications for the specific purpose of serving its customers. Accordingly, if the third party could negotiate a volume discount, the cost of downloading content to the user may be reduced. Even though some communication devices include multiple SIMs (Subscriber Identity Module) and dual NAMs (Number Assignment Module) and may be configured to use different networks for downloads, current communication devices are still not able to receive the benefit of a bulk air price.

A method and electronic device for communication by an electronic device with a server using a network service provider other than its usual network provider is disclosed herein. The described method for redirecting the electronic device communication session to a network provider other than the electronic device's usual network provider may include communicating with a server over a first network provided by the electronic device's usual network provider, receiving a message from the server over the first network, the message including instructions for establishing communication over a second network, processing the instructions by the processor of the electronic device, and initiating communication with the server over the second network in accordance with the instructions.

The instant disclosure is provided to further explain in an enabling fashion the best modes of making and using various embodiments in accordance with the present invention. The disclosure is further offered to enhance an understanding and appreciation for the invention principles and advantages thereof, rather than to limit in any manner the invention. The invention is defined solely by the appended claims including any amendments of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts within the preferred embodiments.

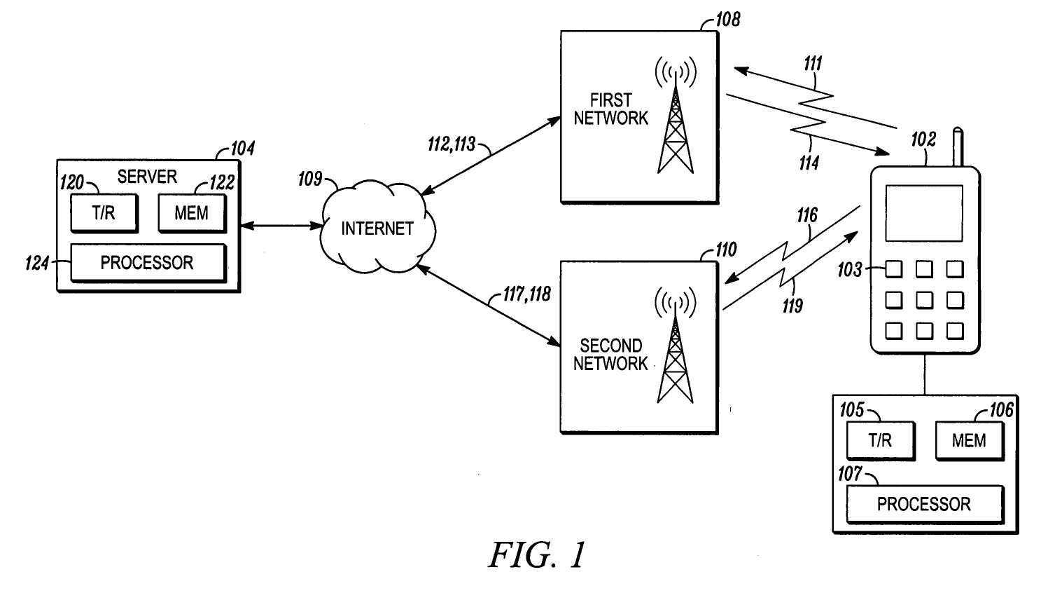

FIG. 1 is an exemplary system diagram depicting an electronic device in communication with a remote server via two different cellular networks. The electronic device 102 includes instruction modules that can initiate communication with the server 104 over at least two networks. The networks shown in FIG. 1 are a first network 108 and a second network 110. One or more networks are in communication with server 104 via an Internet connection 109 or any other wireline or wireless connection. The first network 108 represents the user's own home or preferred network which may be determined by the cellular service provider of the electronic device. Of course, additional networks can be available.

The electronic device 102 represents a wide variety of handheld communication devices that have been developed for use within various networks. Such handheld communication devices include, for example, cellular telephones, messaging devices, mobile telephones, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. Herein, wireless and wired communication technologies include the capability of transferring high content data. For example electronic device 102 can provide Internet access and/or multi-media content access. The electronic device 102 includes input capability such as a key pad 103, a transmitter and receiver 105, a memory 106 and a processor 107.

Communication networks as described herein include those used to transmit digital data both through wires and through radio frequency links. Examples of communication networks are telephone networks, messaging networks, and Internet networks. Such networks include land lines, radio links, and satellite links, and can be used for such purposes as cellular or landline telephone systems, Internet systems, computer networks, messaging systems and satellite systems, singularly or in combination.

The user of the electronic device 102 typically has a business contract with the operator of the user's usual network to that network. The electronic device is typically fitted with a SIM (Subscriber Identity Module) card that includes configuration data for communication over the first network. The configuration data can include, for example, credentials and scanning frequencies. In other situations, an electronic device may be fitted with a dual or multiple network SIM card which may make any one of a number of networks its usual provider. In any event, the user may communicate with the server 104 over its usual provider.

As discussed above, the server 104 will receive initial contact via the first network 108 from the electronic device that may include a request for downloading data. In response the server can send an instruction message to the electronic device to redirect the user to the second network 110 over which the download can be processed. The instruction message can contain, for example, a temporary telephone number, URL, credentials and a frequency band to scan. In this manner, the SIM currently installed on the user's electronic device 102 may be bypassed for the call via the second network 110.

The electronic device 102 may be configured to process a received controlling signal of the instruction message. The process program code that controls the SIM bypass may be provided to the electronic device in a separate download or may be a preconfigured application in the user's electronic device, installed at manufacture. Accordingly, the electronic device, having been preconfigured, uses a message decoding algorithm to identify and provide the user access to the second network.

The user may desire to purchase content from a vendor associated with the server 104. In addition to being a single electronic device, the server may be a plurality of discrete or individual components in communication with one another in a wireless or wired manner. Although the server is depicted as being separate from the first network and the second network, the server could be implemented as part of either or both networks. The elements of the server 104 initiating the message to electronic device 102 over the first network may be different than the elements that establish communication with the electronic device over the second network. The use of the term remote server is for convenience and is not intended to limit the configuration of the server. The server may include components such as a transmitter and a receiver 120, a memory 122 and a processor 124.

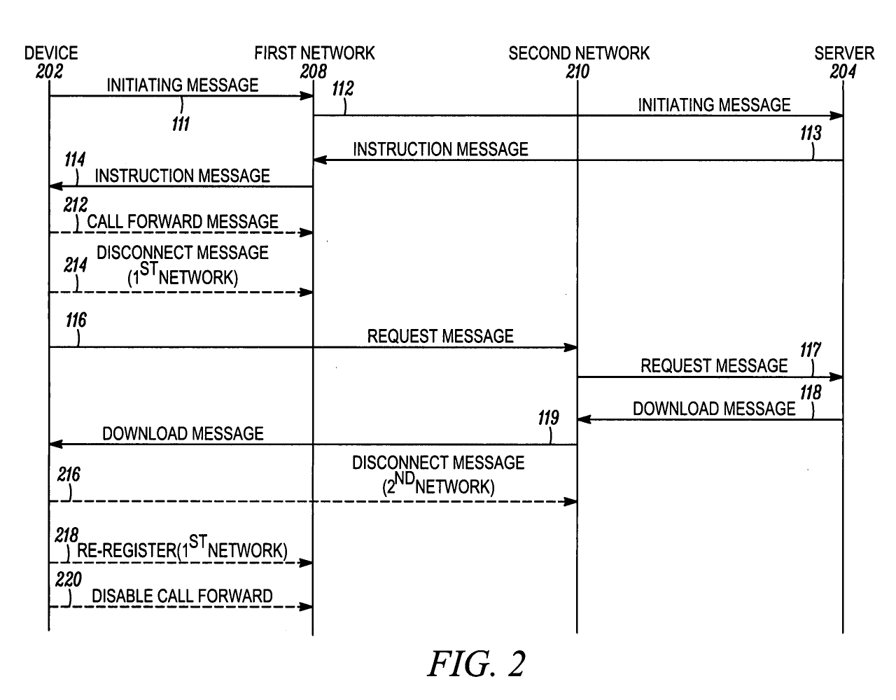

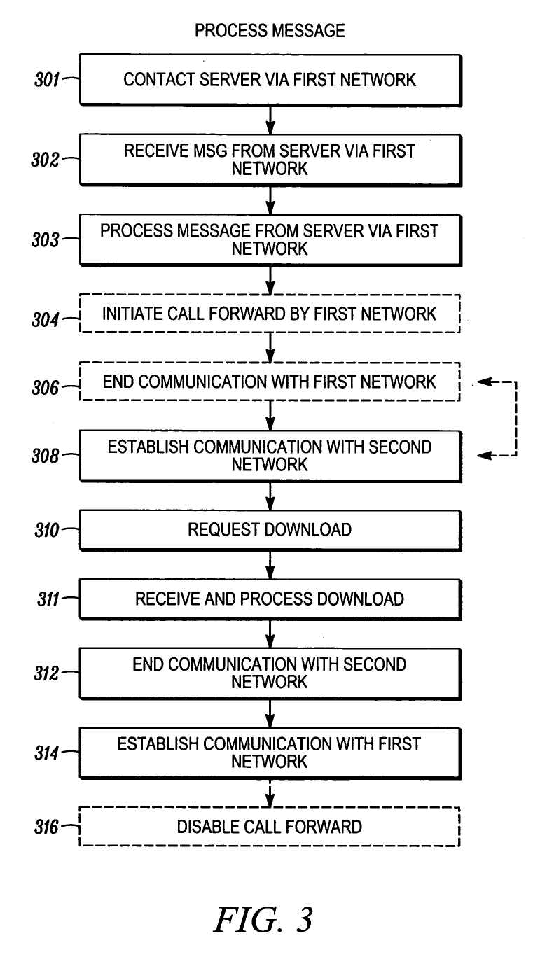

FIG. 1 further illustrates that the electronic device 102 may communicate 112 with the server 104 by initiating, for example, a cellular telephone call to a toll-free number for the purpose of making a transaction with a vendor or other third party. The initial communication 112 may instead be in a different form such as a web interaction, an email message, and/or an SMS message. For example, communication 112 may be initiated while a user visits a website using a mobile station with Internet access. The initial communication 112 could be started by a Java® software application on a web browser, and the software application would handle the processes described later with reference to FIG. 2 and FIG. 3.

In any event, the communication may be for the purpose of purchasing content in the form of downloaded data or obtaining some other service from a vendor associated with the server 104. The data requested can be any type of data including content and software. For example, the vendor may be a broadcaster or broadcasting service that sells digital content such as music, film, games, television or radio shows and sports event replays. Some of the content may involve large digital files that take a substantial period of time to download or require costly network service resources. For example, downloading can be via a broadcast service or via a point-to-point service. Therefore, as part of the purchase price for downloaded content, the vendor may include the cellular communication cost borne by the vendor.

Still referring to FIG. 1, after the electronic device's initial communication message 111 to the server 104, the initiating message 112 passed through the first network 108, a message is generated 113 by the server containing instructions and/or codes for redirecting subscriber communication and is transmitted 114 via the first network 108. Accordingly, the electronic device 102 receives the instruction message from the server. A discussed previously, the message contains instructions and/or codes including those for use by the electronic device 102 to establish communication with the server 104 over the second network 110 for the purpose of receiving, for example, downloaded data from the server. The request for the downloaded data can be processed by the server in response to a request sent 116 over the second network 110 in compliance with the instruction message. The request message 116 is passed 117 through the second network 110 and received by the server 104. In response the server generates and sends a download message 118.

By using a specific second network 110 to transmit downloaded data 119 to the device 102, the vendor associated with the server 104 may provide to the user prepaid or free temporary cellular service while the downloading of the purchased content is taking place. It is understood that all types of high speed data capabilities and downloads of content can be made available to the electronic device on second network 110. For example, a third party business entity such as a content vendor may be able to buy a block of (air) time from a particular network, here second network 110, to provide communications for specific purposes to serve its customers. In so doing, the vendor may obtain a negotiated volume discount. In this way, a content provider may be able to reduce its cost of content delivery via downloads to subscribers over the air. Therefore, while the user of electronic device 102 may not normally use the second network 110, for the transaction, the vendor makes the second network 110 available for a temporary period of time.

The instruction message received at 114 may take any form such as an email message, SMS message, or a response during a website interaction. Any data received may be appropriately decoded and parsed by the electronic device and/or user to obtain the necessary parameters and data elements to establish communication with the server 104 (or one or more other remote units) via second network 110.

In one embodiment, processing the instruction message 114 and sending the download request 116 via the second network as described herein is transparent to the user of the electronic device. Signaling messages and information received 114 can cause the electronic device to immediately and automatically redirect subscriber communication through the network provider and a second network 110 chosen by the vendor. Alternatively, the user may be aware of the change in network providers or even initiate or control the network change.

Now turning to FIG. 2 an exemplary signal flow diagram shows an exemplary process of the electronic device in communication with a server over a first and a second network. The electronic device 102 includes a device 202 signal generator, the first network 108 includes network 208 signal generator, the second network 110 includes a network 210 signal generator, and the server 104 includes server 204 signal generator. As discussed above, the electronic device generates a signal having an initiating message 111 that is processed by the first network which generates a signal having an initiating message 112 for the server 104. The server signal generator 204 sends an instruction message 113 via the first network. Signal generator 208 sends the instruction message 114 to electronic device 102.

The electronic device signal generator optionally sends a call forward message 212 to the first network 208 which will be discussed in more detail below. The optional disconnect message 214 follows the call forward message.

Once the instruction message 114 has been processed by the electronic device 102, the device 202 signal generator sends a download request message 116 via the second network 110, whose network 210 signal generator sends a download request message 117 to the server 104. In response, the server 204 signal generator sends a data download message 118 via the second network 110 whose network 210 signal generator sends data download message 119 to the electronic device 102. Once the transaction is complete, the optional call forward can be reversed by the device 202 signal generator sending a disconnect message 216 to the second network 110 and a re-register message 218 to the first network 108. A disable call forward signal 220 is sent to the first network 108.

FIG. 3 is an exemplary flowchart from the perspective of the electronic device that includes the process of the electronic device 102 contacting 301 the server 104 via the first network 110 and receiving 302 an instruction message 114 from server via first network which the electronic device processes 303. The contents of the instruction message 114 can establish credentials of the electronic device to connect to the second network including providing data to scan at least one predefined frequency band of the second network, and optionally providing instructions to initiate call forwarding 304 from the first network to the second network 110 before ending 306 the initial call on the first network 108. Thus incoming calls and messages may be temporarily forwarded to the visited system and are not missed during the download process. As soon as the user returns to the first network 108, the electronic device can automatically cancel call forwarding.

After the optional initiation of call forwarding, the communication with the first network 108 ends 306 and the establishment 308 of the communication with the second network begins. Alternatively, the end 306 of the communication step with the first network 108 and the establishment 308 of communication with the second network 110 can be in the reverse order.

In still another embodiment, the service provided to the user's electronic device by the first network 108 may still be effective while the user is in communication via the second network 110 without call forwarding. As some communication devices are equipped with dual or multiple SIMs, upon processing the instruction message 114, the electronic device's processor may take on characteristics of a dual or multiple SIM and dual NAM.

Once the communication link is established between the electronic device and the second network, the electronic device requests 310 the download. The requested downloaded data is received and processed 311. When the communication with the second network is completed 312, the communication with the first network can be re-established 314.

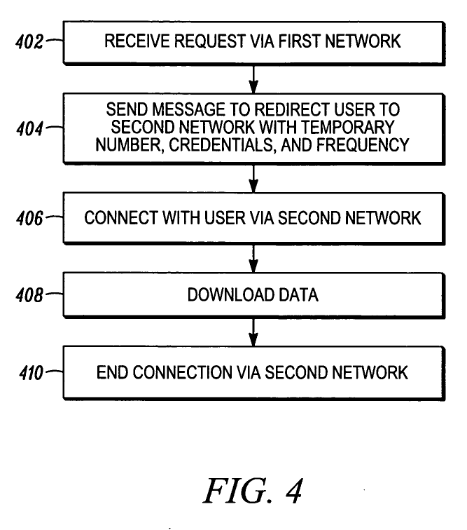

FIG. 4 is an exemplary flowchart from the perspective of the server showing the process of the server communicating with the communication device. The initiating message is received 402 by the server 104 from the electronic device 102 via the first network 108. The server 104 generates the instruction message 114 to redirect the user to the second network 110 with information such as temporary number, credentials and scanning frequency. The server 104 connects 406 with the user's electronic device 102 via the second network 110. When the call is connected, the downloading request is processed 408 and then the call is ended 410.

As mentioned above, while the methods and devices have been described with the example of a cellular telephone call, the discussion is applicable to circumstances including initiating connections with an Internet IP address that can be used to download content. Another alternative embodiment includes a database in the electronic device's memory 106 that stores particular numbers or identifications (e.g. data/IP addresses) with which the user may want to communicate or obtain specific services. Associated with the entries in the database is an indication that the call should be made on a particular network system that is different from the subscriber's usual network. For example, there might be a number which has been downloaded into the electronic device's phonebook which accesses a particular service of a third party provider. The number is marked in the phonebook, so that when the number is dialed or selected by the user, if the unique identifier in the database so indicated, the device moves to an alternate indicated system before placing the call. Again the optional capability of forwarding the user's calls to the new network is possible in order to avoid missing incoming calls.

While the foregoing method and device has been discussed with reference to temporary connection with a first network and a second network, there may be configuration reasons for increasing the number of networks to include third and fourth networks or more as well. Network changes may be transparent to the user as described above. In addition to transferring voice channels, it is understood that all kinds of high speed data capabilities and downloads of content can be made available to the subscriber on the third party's preferred network.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitable entitled.

1. A method for redirecting an electronic device's communication session to a network provider other than the electronic device's usual network provider, the method comprising:
communicating with a remote server over a first network provided by the electronic device's usual network provider;
receiving a message from the remote server over the first network, the message including instructions for establishing communication over a second network;
processing the instructions by a processor of the electronic device; and
initiating communication with the remote server over the second network in accordance with the instructions.

2. A method as recited in claim 1 wherein communicating with the remote server over the first network comprises:
arranging for downloading data to the electronic device.

3. A method as recited in claim 2, further comprising:
downloading data from the remote server to the electronic device.

4. A method as recited in claim 3 wherein downloading is via a broadcasting service.

5. A method as recited in claim 1, wherein processing comprises:
discontinuing communication by the electronic device over the first network.

6. A method as recited in claim 1, wherein the method further comprises:
establishing call forwarding from the first network to the second network.

7. A method as recited in claim 1, wherein processing comprises:
establishing credentials of the electronic device to connect to the second network.

8. A method as recited in claim 1, wherein processing comprises:
scanning at least one predefined frequency band of the second network.

9. An electronic device, comprising:
a communication module for communicating with a remote server over a first network;
a reception module for receiving a message over the first network including instructions from the remote server to establish communication over a second network; and
a processing module for processing the instructions to initiate communication by the electronic device over the second network in accordance with the instructions.

10. An electronic device as recited in claim 9 wherein the communication module is configured to transmit using the electronic device's usual network provider a request for downloading data.

11. An electronic device as recited in claim 10, further comprising:
a receiving module for downloading data from the remote server to the electronic device.

12. An electronic device as recited in claim 11 wherein the data is downloaded via a broadcasting service.

13. An electronic device as recited in claim 9 wherein the processing module is configured to discontinue communication by the electronic device over the first network.

14. An electronic device as recited in claim 9 wherein the processing module is configured to establish call forwarding from the first network to the second network.

15. An electronic device as recited in claim 9 wherein the instructions comprise credentials of the electronic device to connect to the second network.

16. An electronic device as recited in claim 9 wherein the instructions comprise at least one predefined frequency band of the second network.

17. An electronic device as recited in claim 9 wherein the electronic device is a mobile station.

18. A method for redirecting a communication session, comprising:
receiving a first communication initiated by an electronic device over a first network;
transmitting to the electronic device over the first network, a message including instructions to establish communication over a second network;
receiving a second communication initiated by the electronic device over the second network requesting a data transmission to the electronic device; and
transmitting data to the electronic device over the second network.

19. A method as recited in claim 18, wherein the instructions comprise:
credentials for the electronic device to connect to the second network.

20. The method as recited in claim 18, wherein the instructions comprise:
at least one scanning a predefined frequency band of the second network.
